(19) United States
(12) Patent Application Publication
(10) Pub. No.: US 2009/0165302 A1
(43) Pub. Date: Jul. 2, 2009

(54) METHOD OF FORMING A HEATSINK

(76) Inventors: David S. SLATON, Huntsville, AL (US); David L. McDonald, Lacey's Spring, AL (US)

Correspondence Address: General Electric Company;GE Global Patent Operation, PO Box 861, 2 Corporate Drive, Suite 648, Shelton, CT, 06484, US

(21) Appl. No.: 11/967,298

(22) Filed: Dec. 31, 2007

(51) Int. Cl. B23P 15/26; B23K 1/20

(52) U.S. Cl. 29/890.054; 228/174

(57) ABSTRACT

The present disclosure is related to methods for bonding TPG elements to at least a first metal material for forming a heatsink. The heatsinks have an improved thermal conductivity in the X-Y plane.

### BACKGROUND OF THE INVENTION

This disclosure relates generally to methods of bonding thermo pyrolytic graphite (TPG) to metal materials to serve as heatsinks for various uses and, more particularly, to bonding TPG elements to at least one metal material for forming a metal heat-conductive structure for use as a heatsink.

Modem embedded computer systems contain very high thermal power electrical components in a volumetrically constrained environment. The volumes typically do not change as the power dissipation of the components increase, presenting significant challenges in the management of component temperatures. In the past, a variety of direct cooling techniques, such as active or passive heatsinks including high thermally conductive materials such as aluminum and/or copper have been used to manage rising temperatures. These materials, however, are only sufficient if a relatively large amount of surface area is presented to the airstream, necessitating a physically larger heatsink structure that occupies a large amount of the total available volume. As the physical size of the heatsink increases, the ability of the material to rapidly carry heat to the extremities of the heatsink, thereby exposing the heat to the airstream, is diminished.

Thermo Pyrolytic Graphite (TPG) materials have been found to have the ability to provide better heat conduction in a single (X-Y) plane as compared to conventional metal materials. Furthermore, TPG has been found to have an improved overall conductivity as compared to copper. Recently, a method has been developed to embed a TPG material into an aluminum structure using a diffusion bonding process. The diffusion bonding process, while resulting in a suitable thermal contact between the TPG material and the aluminum structure, has limitations in that specialized equipment is needed to create the TPG-embedded structures in a time-consuming process, resulting in an expensive product.

As such, there is a need for a method to create a cost-effective product having TPG bonded to one or more metal materials, such as an aluminum structure, to form a metal heat-conducting structure (i.e., heatsink) to provide effective thermal conductivity in the X-Y plane. Additionally, there is a need for such a method that is easily reproducible and performed in various facilities using various types of equipment.

### BRIEF DESCRIPTION OF THE INVENTION

In one aspect, a method for bonding thermo pyrolytic graphite (TPG) to a first metal material and a second metal material to form a heatsink is provided. The method includes forming at least one hole through a TPG element; forming at least one via in the first metal material, wherein the via is configured to be complementary to the hole through the TPG element; providing a thermal spacer made from the second metal material, wherein the thermal spacer is configured to be complementary to a heat source element; applying a metal-based coating to an outer surface of the TPG element; and bonding the via in the first metal material and the thermal spacer of the second metal material to the coated surface of the TPG element. The via, thermal spacer, and hole are bonded to form the heatsink configured to allow heat from the heat source element to be conducted through the thermal spacer to the via through the hole in the TPG element.

In another aspect, a method for bonding thermo pyrolytic graphite (TPG) to a first metal material and a second metal material to form a heatsink is provided. The method includes forming at least one hole through a TPG element; forming at least one via in the first metal material, wherein the via is configured to be complementary to the hole through the TPG element; providing a thermal spacer made from the second metal material, wherein the thermal spacer is configured to be complementary to a heat source element; and bonding the via in the first metal material and the thermal spacer of the second metal material to the TPG element using an electroplating process. The via, thermal spacer, and hole are bonded to form the heatsink configured to allow heat from the heat source element to be conducted through the thermal spacer to the via, and through the hole in the TPG element.

In another aspect, a method for bonding thermo pyrolytic graphite (TPG) to a first metal material to form a heatsink is provided. The method includes forming at least one hole through a TPG element; applying a metal-based coating to an outer surface of the TPG element; depositing at least one soldering ball to an outer surface of the first metal material, wherein the soldering ball is configured to fill the hole through the TPG element; pressing the first metal material to the TPG element such that the soldering ball fills the hole; and heating the first metal material to solder the first metal material to the TPG element.

### BRIEF DESCRIPTION OF THE DRAWINGS

FIG. 1 depicts a TPG element, a first metal material, and a second metal material to be bonded according to a method of the present disclosure.

FIG. 2 depicts a thermal interface material applied to a thermal spacer made from a second metal material for use in a method according to the present disclosure.

FIG. 3 depicts a heatsink formed using a method of one embodiment according to the present disclosure.

FIG. 4 depicts an X-plane, a Y-plane, and a Z-plane of thermal conductivity in a heatsink.

FIG. 5 depicts a metal fin assembly for use in the method according to the present disclosure.

FIG. 6 depicts heatsink formed using a method of a second embodiment according to the present disclosure.

### DETAILED DESCRIPTION OF THE INVENTION

The present disclosure is related to bonding thermo pyrolytic graphite (TPG) to at least one metal material for forming a heatsink. As used herein, “TPG” refers to any graphite-based material in which the graphite is aligned in one direction for optimal heat transfer. The materials are typically referred to as “aligned graphite”, “TPG”, and/or “Highly Oriented Pyrolytic Graphite (HOPG)”. The TPG elements provide improved thermal conductivity in the X-Y plane of the metal heat-conducting structure (i.e., heatsink). More specifically, it has been found that by using the methods of bonding TPG elements to at least one metal material as provided in the present disclosure, temperatures created by the use of electrical systems, such as computer systems, can be lowered by about 12° C. or more as compared to conventional thermal solutions. This improved temperature release allows for almost a doubling of the electrical systems' power capacity in the same volume environment. Furthermore, the increase in power may result in systems being supported that could not have otherwise been so, or may allow existing systems to be used in environments having higher ambient temperatures.

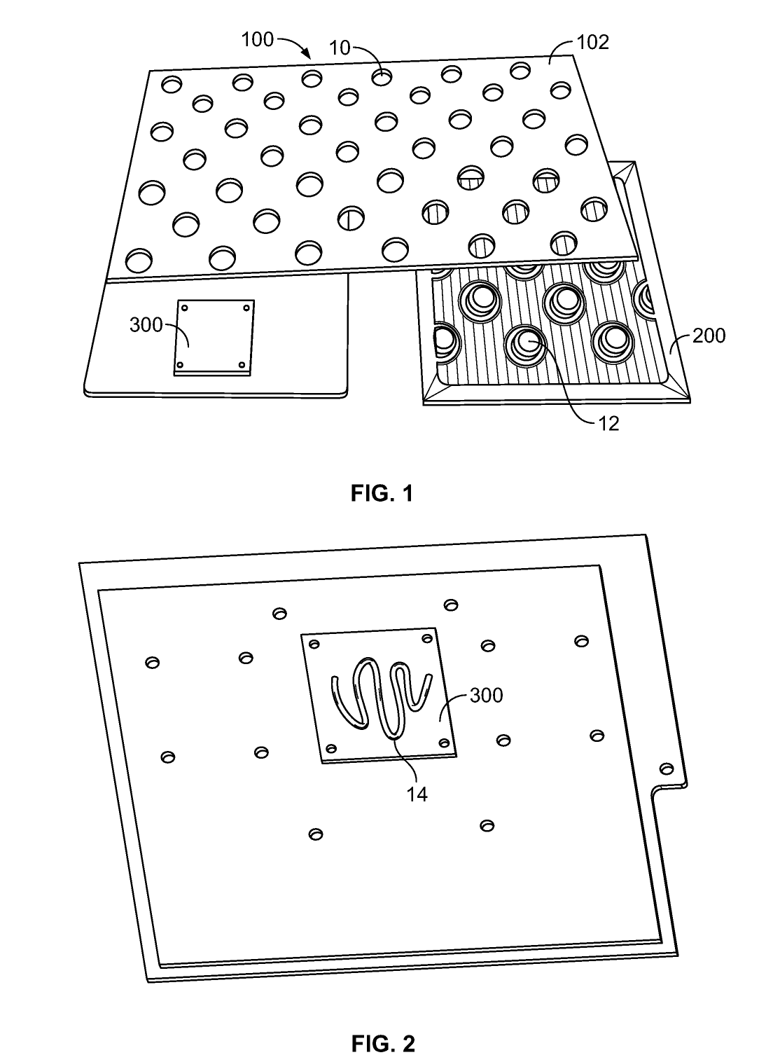

As noted above, the heatsink is formed by bonding a TPG element to at least one material. In one embodiment, as shown in FIGS. 1-3, the TPG element is bonded to a first metal material and a second metal material for use in a heatsink. In this embodiment, at least one hole 10 is formed through a TPG element 100. At least one via 12 is formed in a first metal material 200. The via 12 formed in first metal material 200 and a thermal spacer 300 made of second metal material are bonded to a coated surface of TPG element 100.

TPG element 100 can be obtained using any method and/or equipment known in the art for fabricating TPG elements. TPG elements 100 can further be obtained commercially from a supplier, such as Momentive Performance Material located in Wilton, Conn.

In one embodiment, as shown in FIG. 1, TPG element 100 is configured as a planar TPG element. In a particular embodiment, TPG element 100 is a planar sheet having a substantially rectangular shape. Furthermore, while the dimensions of TPG element 100 may vary, in one embodiment, TPG element 100 has a thickness of about 0.06 inches.

At least one hole 10 is formed through TPG element 100. Holes 10 can be formed using any method known in the art. In a particular embodiment, as shown in FIG. 1, a plurality of holes 10 are formed through TPG element 100. Dimensions of holes 10, a number of holes 10 and/or spacing between holes 10 formed through TPG element 100 will depend on the desired end product. In one embodiment, TPG element 100 includes a suitable number of holes 10, each having a relatively smaller diameter to reduce a flow of solder material or thermally conductive adhesive (when used) through holes 10 and interfering with the electrical and/or physical connections of TPG element 100, while having a suitable diameter to allow solder material or adhesive through holes 10 to create a sufficient mechanical bond. Furthermore, by using smaller diameter holes 10, a capillary action effect can be produced, thereby allowing for a better wicking action of the solder material or adhesive up through holes 10.

Holes 10 can have any suitable shape known to one skilled in the art. Without limiting the scope of the present disclosure, each hole 10 may have a suitable shape including, for example, a circular, an oval, a square, a rectangular, or a triangular shape. In one embodiment, each hole 10 has a circular shape as circular holes are easier to manufacture. In a particular embodiment, each circular hole has a diameter of approximately 0.5 inches.

Additionally, at least one via 12 is formed in a first metal material 200. In one embodiment, the via 12 is configured to be positioned within a complementary or corresponding hole 10 formed through TPG element 100. As such, dimensions of vias 12, number of vias 12, and/or spacing between vias 12 formed in first metal material 200 depend upon the corresponding dimensions and/or number of holes 10 formed through TPG element 100. In one embodiment, a plurality of vias 12 are formed through first metal material 200, as shown in FIG. 1.

In a particular embodiment, as shown in FIG. 1, one or more vias 12 are configured to be button-shaped to fill holes 10 formed through TPG element 100.

In a further embodiment, via 12 is strategically configured into one or more individual mushroom-cap shaped button (not shown). By using a mushroom-cap shape, vias 12 are free to float apart from each other to allow for better bonding with TPG element 100 and, thus, with the heat source element (not shown). In one embodiment, when vias 12 are mushroom cap shaped, vias 12 further include stems. The stems extend through holes 10; that is, the stems extend through the entire thickness of TPG element 100. Other suitable shapes for vias 12 can include stem-only mushroom vias; that is mushroom-shaped vias having the stems only.

In an alternative embodiment, a hole is defined through a center of each vias 12. The hole can be sized and configured to allow for a separate mechanical coupling component to be inserted, thereby strengthening the connection between first metal material 200 and TPG element 100. For example, in one embodiment, the hole can be sized and configured to accept a screw or rivet to facilitate coupling the metal fin or conduction-cooled heatframe, as described herein, of a first metal material 200 to via 12 of a first metal material 200. The mechanical coupling component can be provided prior to, subsequent to, or simultaneously with, the bonding.

First metal material 200 is made from a metal material having a suitable thermal conductivity. For example, first metal material 200 may include aluminum, copper, indium, and combinations thereof. In one embodiment, first metal material 200 is aluminum. Both aluminum and copper have been shown to provide high conductivity when used in heatsinks. More specifically, aluminum provides good thermal conductivity in a “Z” plane when used in heatsinks. However, as noted above, aluminum and copper alone fail to provide sufficient heat transfer in an X-Y plane and, as such, the present disclosure has combined TPG with aluminum, copper, or combinations thereof. FIG. 4 is provided to show the X plane, Y plane, and Z plane of a heatsink 700.

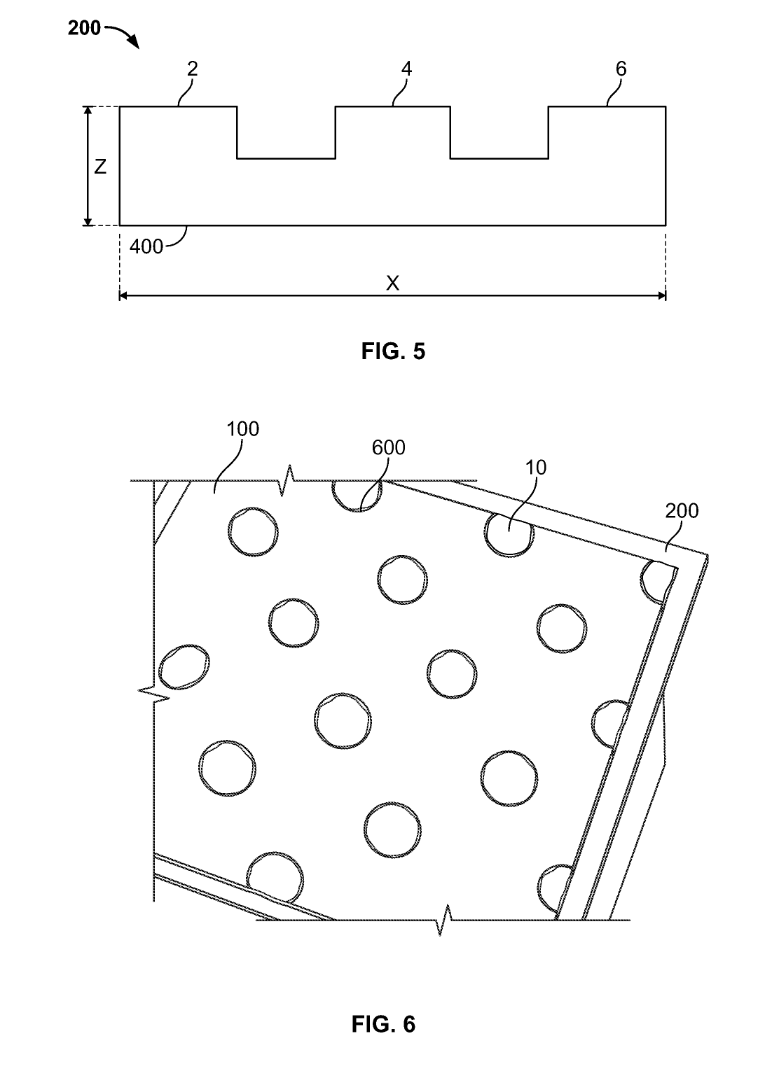

In one embodiment, as shown in FIG. 5, first metal material 200 includes a metal fin assembly 400. Metal fin assembly 400 provides a greater surface area of thermally conductive metal material 200, thereby facilitating efficient and effective heat release from a heat source element. In one particular embodiment, metal fin assembly 400 is approximately 6 inches×5 inches and is approximately 0.3 inches in thickness. Fins 2, 4, 6 of fin assembly 400 in one embodiment are approximately 0.24 inches in height and approximately 0.024 inches thick, and a spacing between adjacent fins is approximately 0.096 inches. It should be understood by one skilled in the art, that fins 2, 4, 6 can be sized and/or spaced other than as described above without departing from the scope of the present disclosure. More specifically, any size and/or spacing of fins 2, 4, 6 as known in the art of fin assemblies 400 and guided by the teachings herein provided can be used in the present disclosure.

When first metal material 200 includes metal fin assembly 400, it should be recognized that vias 12 formed in first metal material 200 may be formed as separate components from fins 2, 4, 6 of metal fin assembly 400.

In an alternative embodiment, first metal material 200 is a conduction-cooled heatframe intended to transfer heat to an edge of a heatframe. Conduction-cooled heatframes are known in the art and are commercially supplied, such as from the commercial supplier, Simon Industries, located in Morrisville, N.C.

As shown in FIG. 1, a thermal spacer 300 made from a second metal material is provided. Thermal spacer 300 is configured to be complementary to a heat source element (not shown), as described more fully below. Thermal spacer 300 couples a heat source element to TPG element 100. Thermal spacer 300 can be the same material or a different material than first metal material 200 described above. Suitable second metal materials for the thermal spacer 300 include, for example, metal materials including aluminum, copper, indium, and combinations thereof. In a particular embodiment, the thermal spacer is copper.

Thermal spacers 300 can have any suitable dimensions known to one skilled in the art. In one embodiment, the dimensions of thermal spacer 300 are approximately 1.4 inches×1.4 inches×0.25 inches.

As noted above, thermal spacer 300 is configured to be complementary to a heat source element. Generally, the heat source element is an electrical heat source element. For example, the heat source element is an integrated semiconductor circuit. As noted above, during use of the heat source element, such as an integrated circuit, a large amount of heat is generated that must be released to the outside environment to prevent overheating and/or malfunctioning of the heat source element. For example, in one embodiment, an integrated circuit dissipates approximately 30 Watts or greater of thermal power, with die temperatures reaching an excess of about 100° C. This heat must be released to prevent overheating of the integrated circuit.

In addition to TPG element 100, first metal material 200, and thermal spacer 300, in one embodiment, a third metal material (not shown) may be used to provide independent vias from vias 12. The vias formed in the third metal material are configured to be complementary to holes 10 in TPG element 100. The vias couple TPG element 100 to the heat dissipating structure of the heatsink, typically fins 2, 4, 6 of metal fin assembly 400 (shown in FIG. 5). The third metal material for providing the via can be the same material or a different material than first metal material 200 and thermal spacer 300 described above. Suitable third metal materials can include, for example, metal materials including aluminum, copper, indium, and combinations thereof. In a particular embodiment, the via is copper.

As with vias 12 formed within first metal material 100, the vias of the third metal material can be any suitable dimensions known to one skilled in the art. In one embodiment, the dimensions of the vias within the third metal material are approximately 0.5 inches in diameter and approximately 0.25 inches in thickness.

In one embodiment, the method of the present disclosure includes applying a metal-based coating material to an outer surface 102 of TPG element 100. More specifically, when used, the metal-based coating material is applied to outer surface 102 facing towards first metal material 200. A layer of metal material such as aluminum, copper, iron, silver, gold, nickel, zinc, tin, or a combination thereof, is applied to outer surface 102of the TPG element 100. In one embodiment, the metal-based coating material is a copper coating material with a nickel overcoat. In an alternative embodiment, an indium metal-based coating material is used.

The metal-based coating material suitably provides mechanical strength and a point of contact for the solder material or adhesive (if used) during heating and attachment. The metal-based coating material may also provide a compliant surface that conforms to the surface to which it is coupled (e.g., vias 12). The metal-based coating material is typically at least about 0.001 inches thick. More suitably, the copper/nickel based coating material is applied to TPG element 100 having a thickness of from about 0.0005 inches to about 0.002 inches.

The metal-based coating material can be applied to outer surface 102 of TPG element 100 in any suitable pattern known in the art. In one embodiment, the metal-based coating material is applied in a cross-hatched pattern. In an alternative embodiment, the metal-based coating material is applied in a striped pattern.

In one embodiment, a thermal interface material 14 is applied to the surface of via 12, a part of first metal material 200 and, and the metal fin or conduction-cooled heatframe part of the first metal material 200. When more than one metal material is used, for example, when thermal spacer 300 and the third metal material are used, the thermal interface material 14 is applied between a surface of first metal material 200 and a via of the third metal material.

The thermal interface material fills imperfections in the surface finish of first metal material 200 and thermal spacer 300 to create a thermal interface with a lower thermal impedance. In one embodiment, as shown in FIG. 2, a thermal interface material 14 is TIC-4000, commercially available from Bergquist located in Chanhassen, Minn., and is applied in a striped pattern to thermal spacer 300.

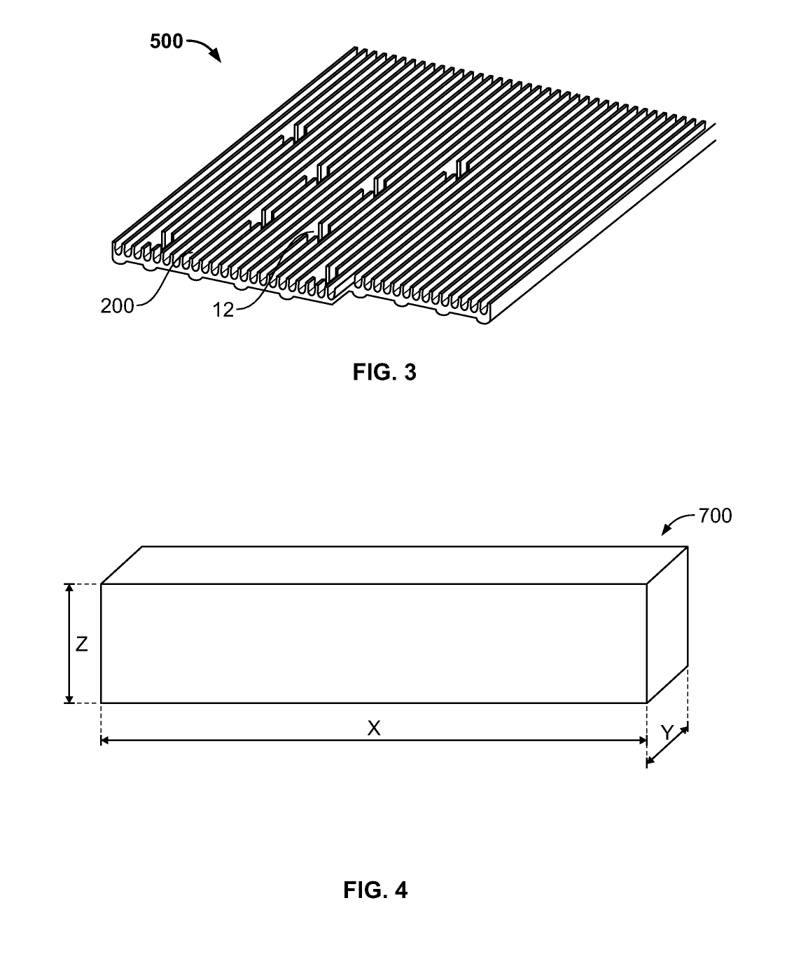

Now referring to FIG. 3, to form heatsink 500, via 12 in first metal material 200, thermal spacer 300 (when used, and not shown in FIG. 3), the via in the third metal material (when used, and not shown in FIG. 3), and TPG element 100 (not shown in FIG. 3) are bonded together. Suitably, now referring collectively to FIGS. 1-3, vias 12, thermal spacer 300, and TPG element 100 are bonded to form heatsink 500 configured facilitate conducting heat from a heat source element (not shown) through thermal spacer 300 to TPG element 100, and then through hole 10 of TPG element 100 to via 12 in first metal material 200, and then to the outside environment.

In one embodiment, the components are bonded using a suitable electroplating process. Any suitable electroplating process known in the art can be used in the methods of the present disclosure. Generally, an electrolytic apparatus containing an anode end, an opposing cathode end, and a non-conductive housing between the anode and cathode ends as known in the art is used for the electroplating process. The housing of the electrolytic apparatus includes an electrolytic solution. In one embodiment, the process includes contacting TPG element 100, first metal material 200, thermal spacer 300 (when used), and the third metal material (when used) simultaneously with an electrolytic solution. The plating is typically deposited in multiple iterations to build up layers to fill any voids that may be present. More specifically, once TPG element 100, first metal material 200, thermal spacer 300, and the third metal material are contacted with the electrolytic solution, electroplating is carried out by passing an electric current between the anode and cathode ends of the electrolytic apparatus.

In an alternative embodiment, TPG element 100, first metal material 200, thermal spacer 300 (when used), and the third metal material (when used) are bonded together using a soldering process (See FIG. 6). In a particular embodiment, the method includes depositing at least one soldering ball (not shown) on an outer surface of first metal material 200 (either in combination with vias 12 described above, or without vias 12). Typically, however, multiple soldering balls are deposited onto first metal material 200. Suitably, like vias 12 described above, soldering balls are configured to fill holes 10 of TPG element 100, to fill any gaps around thermal spacer 300 (when used, and not shown in FIG. 6), and bind first metal material 200 and thermal spacer 300 (when used) to TPG element 100 using conventional soldering mechanisms. In another particular embodiment, solder 600 is applied to the interface between vias 12, thermal spacer 300 (when used; not shown in FIG. 6), and TPG element 100. Regardless of how solder is applied, via pre-deposited solder balls or externally applied solder 600, the solder is heated to allow it to melt and simultaneously fill gaps between first metal material 200(and thermal spacer 300 and the third metal material, when used, and not shown in FIG. 6) and TPG element 100 are pressed together to allow the molten soldering balls to flow through and fill the holes 10 and gaps of TPG element 100. The temperature at which solder 600 melts will vary depending on the material used for solder 600, but typically, solder 600 is heated to temperatures of about 185° C. or higher. Once cooled, solder 600 will solidify and adhere around TPG element 100. While described herein as being conducted simultaneously, it should be recognized by one skilled in the art that first metal material 200 and thermal spacer 300 (not shown) (and third metal material, when used) and TPG element 100 can be pressed together and then heated or vice versa without departing from the scope of the present disclosure.

Suitable solder can be made from materials including, without limitation, lead/tin alloys, lead-free tin alloys, tin/silver alloys, tin/silver/copper alloys, and tin/silver/copper/antimony alloys. In one embodiment, solder paste is introduced at holes 10 and gaps of TPG element 100. The solder paste contains particles of lead/tin alloy suspended in a gel, which is applied in a wet state to first metal material 200 (and thermal spacer 300 and the third metal material, when used). Heat is applied to melt the non-conductive gel away and the solder 600 melts and bonds TPG element 100 to first metal material 200.

In a further embodiment, the method of the present disclosure includes bonding TPG element 100, first metal material 200, and thermal spacer 300 using a thermally conductive adhesive. Typically, the adhesive is applied to at least one of TPG element 100, first metal material 200, thermal spacer 300, and the third metal material. More specifically, the adhesive may generally be applied in a semi-solid state, such as in a paste, or gel-like form using any method known in the art.

In one embodiment, the thermally conductive adhesive is Arctic Silver Epoxy, commercially available from Arctic Silver, Inc., located in Visalia, Calif. Amounts of adhesive used will typically depend upon the specific heatsink configuration. In one embodiment, approximately 1.5 mL of adhesive is applied using a syringe and a spatula to spread the adhesive into a thin layer over TPG element 100, first metal material 200, and thermal spacer 300.

In one embodiment, the heatsink is applied to the heat source element using a TIC400 thermal grease available from Bergquist, located in Chanhassen, Minn.

As noted above, while the above-described methods for bonding (e.g., electroplating process, soldering process, and adhesive) are described singularly, it should be understood that any combination of the three bonding methods can be used in combination to form a heatsink without departing from the scope of the present disclosure.

While the invention has been described in terms of various specific embodiments, those skilled in the art will recognize that the invention can be practiced with modification within the spirit and scope of the claims.

What is claimed is:

1. A method for forming a heatsink, the method comprising:
forming at least one hole through a thermo pyrolytic graphite (TPG) element;
forming at least one via in a first metal material, each via of the at least one via configured to be positioned within a corresponding hole of the at least one hole;
providing a thermal spacer made from a second metal material, the thermal spacer configured to receive a heat source element;
applying a metal-based coating to an outer surface of the TPG element; and
bonding the at least one via and the thermal spacer to the coated outer surface of the TPG element, the thermal spacer and the TPG element bonded to form the heatsink to facilitate conducting heat from the heat source element through the thermal spacer to each via, and through the corresponding hole.

2. A method in accordance with claim 1, comprising forming the at least one hole through a planar TPG element.

3. A method in accordance with claim 1, wherein forming at least one hole comprises forming a plurality of holes through the TPG element, the plurality of holes formed in one of a circular, an oval, a square, a rectangular, and a triangular shape.

4. A method in accordance with claim 1, comprising forming a plurality of vias in the first metal material.

5. A method in accordance with claim 4, wherein the plurality of vias are independent vias from one another.

6. A method in accordance with claim 1, wherein the at least one via is formed in the first metal material being selected from the group consisting of aluminum, copper, indium, and combinations thereof.

7. A method in accordance with claim 6, wherein the at least one vias is formed in a metal fin assembly.

8. A method in accordance with claim 6, wherein the at least one via is formed in a conduction-cooled heatframe.

9. A method in accordance with claim 1, wherein the thermal spacer is provided from the second metal material being selected from the group consisting of aluminum, copper, indium, and combinations thereof.

10. A method in accordance with claim 1, wherein a copper-nickel coating material is applied to the outer surface of the TPG element.

11. A method in accordance with claim 1, wherein the at least one via and the thermal spacer are bonded to the coated outer surface of the TPG element using a thermally conductive adhesive.

12. A method in accordance with claim 1, wherein the at least one via and the thermal spacer are bonded to the coated outer surface of the TPG element using solder.

13. A method for forming a heatsink, the method comprising:
forming at least one hole through a thermo pyrolytic graphite (TPG) element;
forming at least one via in a first metal material, each via of the at least one via configured to be positioned within a corresponding hole of the at least one hole;
providing a thermal spacer made from a second metal material, the thermal spacer configured to receive to a heat source element; and
bonding each via and the thermal spacer to the TPG element using an electroplating process, each via, the thermal spacer, and the TPG element bonded to form the heatsink configured to facilitate conducting heat from the heat source through the thermal spacer to each via, and through the corresponding hole.

14. A method in accordance with claim 13, wherein forming at least one hole comprises forming a plurality of holes through the TPG element, the plurality of holes formed in one of a circular, an oval, a square, a rectangular, and a triangular shape.

15. A method in accordance with claim 13, comprising forming a plurality of vias in the first metal material.

16. A method in accordance with claim 13, wherein at least one via is formed in the first metal material being selected from the group consisting of aluminum, copper, indium, and combinations thereof.

17. A method in accordance with claim 16, wherein the at least one via is formed in a metal fin assembly.

18. A method in accordance with claim 13, wherein the thermal spacer is provided in the first metal material being selected from the group consisting of aluminum, copper, indium, and combinations thereof.

19. A method in accordance with claim 17, further comprising applying a thermal interface between the outer surface of the vias of the first metal material and the metal fin assembly of the first metal material

20. A method for forming a heatsink, the method comprising:
forming at least one hole through a thermo pyrolytic graphite (TPG) element;
applying a metal-based coating to an outer surface of the TPG element;
depositing at least one soldering ball on an outer surface of a first metal material, the at least one soldering ball configured to fill a corresponding hole of the at least one hole;
pressing the first metal material to the TPG element such that the soldering ball substantially fills the corresponding hole; and
heating the first metal material to solder the first metal material to the TPG element.

21. A method in accordance with claim 20, wherein forming at least one hole comprises forming a plurality of holes through the TPG element, the plurality of holes formed in one of a circular, an oval, a square, a rectangular, and a triangular shape.

22. A method in accordance with claim 20, wherein depositing at least one soldering ball comprises depositing a plurality of soldering balls to the outer surface of the first metal material.

23. A method in accordance with claim 20, wherein at least one soldering ball is deposited on an outer surface of the first metal material being selected from the group consisting of aluminum, copper, indium, and combinations thereof.

24. A method in accordance with claim 20, wherein depositing the at least one soldering ball to the outer surface of the first metal material comprises depositing the at least one soldering ball being selected from the group consisting of aluminum, copper, indium, and combinations thereof to the outer surface of the first metal material.

25. A method in accordance with claim 20, wherein applying the metal-based coating to an outer surface of the TPG element comprises applying a copper-nickel coating material to the outer surface of the TPG element.

26. A method in accordance with claim 20, further comprising applying a thermal interface material between the outer surface of the first metal material and an outer surface of the TPG element.
